(19) United States
(12) Patent Application Publication
(10) Pub. No.: US 2005/0114301 A1
(43) Pub. Date: May 26, 2005

(54) Method and server for providing database inquiry services

(76) Inventors: Vesa-Matti Jokinen, Espoo (FI); Juha Tammela, Masala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/497,071

(22) PCT Filed: Dec. 4, 2002
(86) PCT No.: PCT/FI02/00987

(30) Foreign Application Priority Data
Dec. 7, 2001 (FI) 20012417

(51) Int. Cl. G06F 7/00

(52) U.S. Cl. 707/3

(57) ABSTRACT

The present invention relates to computer database searches or inquiries carried out with a user device of a communications network. In an embodiment of the present invention, a person who is querying databases using a user communication device (3) and an inquiry application located on the network server (1) can receive an additional trigger link from the inquiry application in case predefined conditions are met in the query. The querying person may use the trigger link to inform predefined parties (7) that he/she has important and urgent information to share with them. In an alternative embodiment, the inquiry application (1) will deliver a notification to one or more predefined recipient (7) automatically in case the predefined conditions are met in the query.

### BACKGROUND OF THE INVENTION

The present invention relates to computer database searches or inquiries, and more precisely, database inquiries carried out with a user device of a communications network.

In a typical database search, a user queries the database by selecting a set of criteria (a request) and submitting those criteria to a database engine. Many different methods have been utilized to facilitate the creation of database requests by the user. In some user interfaces, a user answers a series of questions, fills out an on-line form, or selects from a finite number of choices. Once such search request is submitted, the database engine returns the search results meeting the criteria, if any, and the user interface displays the results. A method that is very often used to display the data returned from the database query, is the hierarchical map or tree structure, which enables the user to navigate from the route of the tree through one or more subcategories (branches) in order to find the desired information.

Most of these services are offered on the Internet and they are best suited for fixed workstations which are connected to a wired telecommunications network, use sufficiently high-speed transmission connections and have enough processing capacity and a large graphic display. However, when the user is using a wireless portable communication device, such as a mobile phone or a communicator, problems arise. One of the problems is the typically low transmission rate (for example 9.6 kbit/s) of the radio channel over the air interface. This problem is nowadays alleviated by high-speed data services offered by the modern digital mobile networks. The more serious problem is the user device itself. Typical requirements of the wireless end-device, such as the mobile phone, include a very small size, light weight, low power consumption and a low price. These requirements result in use of less effective microprocessors, less memory capacity, smaller display and lower display resolution, and a limited keyboard in comparison with the standard personal computers. Therefore, dedicated data communication and inquiry techniques have been developed for the wireless environment.

WO 98/11744 discloses the implementation of a data inquiry service in a digital mobile communications network using a short message service. Typically, the inquiries are made to servers on the Internet. For this purpose, a short message center (SC) is connected to the Internet and employs the HTML (HyperText Markup Language), HTTP (HyperText Transfer Protocol) and TCP/IP (Transmission Control Protocol/Internet Protocol) protocols towards the Internet. Short messages are sent in a conventional manner between the short message center and the mobile station. The user sends a short message including an identifier indicating the desired web page to the short message center. The short message center establishes a connection to a desired WWW (World Wide Web) server through the Internet, receives the web page from the Internet and stores said page. The relevant part is distinguished from the web page and sent to the mobile station in a short message. This relevant part of the web page can be identified using a predetermined criterion, which is common to all subscribers, or it may be based on criterion received from the mobile station, such as a keyword. The mobile station processes the received short message in a conventional manner and displays it to the user. This approach provides the advantage that the mobile station only needs to support the short message service in order to utilize inquiry services, or Internet services. Such an inquiry service based on the short message service is commonly referred to as smart messaging. Different operators and service providers have applied smart messaging. For example, when a short message is sent to number 400 in the Sonera GSM mobile communications network, and the short message contains a predetermined search word, a reply including information associated with the search word is obtained. The smart messaging services typically also comprise a menu structure, in which a desired topic can be selected from a predetermined menu or a corresponding web site can be searched for using search words. The menus can each be packed into a single short message, and the list of headlines can be divided into blocks in the same way as the article.

Also browsing web pages by means of mobile stations is difficult, particularly owing to the limitations of the mobile stations' display. On this account, a specific technology has been developed for mobile stations, referred to as a WAP (Wireless Application Protocol), in which WML pages (Wireless Mark-up Language) are transferred to the mobile stations The properties of the WML pages are better suited to the small displays in mobile stations and to the transmission capacity of the mobile network. The Internet may comprise web pages directly presented in the WAP/WML format, or conventional WWW/HTML pages can be converted into the WAP/WML format in a particular gateway unit (WAP gateway). The gateway apparatus is typically located at the interface between the mobile communications network and the Internet. The user sends a request concerning a particular web page to the WAP gateway using a micro browser in the mobile station, and the WAP gateway retrieves the web page from the Internet and converts it to a WML page, which is thereafter loaded to the micro browser. The micro browser shows the WML page on the mobile station display. Also in WAP applications hierarchical tree structures or selection menus are employed for allowing the user to navigate to the desired information.

### DISCLOSURE OF THE INVENTION

An object of the present invention is to provide a database inquiry method offering a new functionality for a user communication device.

This object is achieved by means of a method, a server, a communications system, a computer program product and a computer program according to the independent claim 1, 9, 18, 19 and 20, respectively. The preferred embodiments of the invention are disclosed in the dependent claims.

In an embodiment of the present invention, a person who is querying databases using a user communication device and an inquiry application located on the network side can receive an additional trigger link from the inquiry application in case predefined conditions are met in the query. The querying person may use the trigger link to inform predefined parties that he/she has important and urgent information to share with them. In an alternative embodiment, the inquiry application will deliver a notification to one or more predefined recipient automatically in case the predefined conditions are met in the query.

An example of typical use of the functionality is related to a police supervision case where the statuses of persons or vehicles are checked by browser-based database applications using a user communication device of a communication system, such as a mobile phone with a WAP capability. In case the subjected person or vehicle is tied in the inquiry application to a high risk or equivalent serious criminal activity, a silent alarming link will be presented along with other inquiry results in a browser view returned by the inquiry application. The browsing person may use the link to trigger a silent alarm or information transfer to the target audience predefined into or determined by the inquiry application. By means of the present invention, the inquiring end-user is informed of the need for sending an alarm without a customer (e.g. suspected person) noticing it. The inquiring user will have the possibility to continue checking the suspected person normally and silently alarm the other units at the same time. The totally automated triggering of the silent alarm can be used for high-risk cases. In this case, the application recognizes the high-risk query and generates an alert or notice automatically. The work safety of the users, such as policemen, will increase in comparison with the traditional system wherein voice communication is used for both the database queries and alarms. As a matter of fact, in case of high-risk customers, there have been no physical mechanisms to warn field forces and to escalate the case simultaneously. The receiver of the alarm message gets the alert or notice in such a format (such as a link to the related case) that he/she can start the case follow up straight from the situation which took place before alerting was made.

### BRIEF DESCRIPTION OF THE DRAWINGS

The invention will be described by means of the preferred embodiments and referring to the accompanying drawings, in which

FIG. 1 is a block diagram illustrating the architecture of the system wherein the present invention can be applied,

FIGS. 2A, 2B and 2C are flow diagrams illustrating the operation of the inquiry application,

FIGS. 3A-3N illustrate the browser views during inquiry, alert message creation and sending, and

FIGS. 4A-4B illustrate browser views at a mobile phone receiving a push alert message.

### THE PREFERED EMBODIMENTS OF THE INVENTION

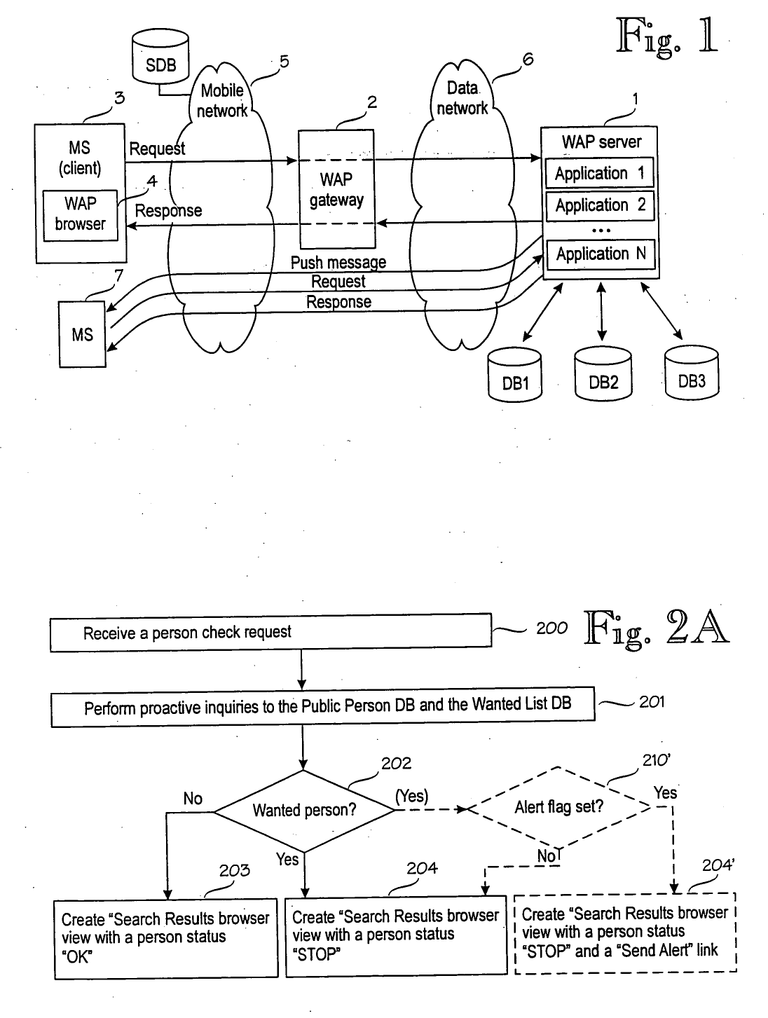

Referring to FIG. 1, a user communication device 3 of the wireless network 5 is provided with a micro browser supporting an appropriate transmission protocol for communication with a server 1 on the network side. In the preferred embodiments of the invention the mobile network is a digital mobile network, such as TETRA, GSM, or UMTS, and the wireless device 3 is a mobile terminal or mobile station MS for such a digital mobile communications network. However, the invention is not restricted to any specific digital mobile communications system or user communication device but is universally applicable. In the preferred embodiment of the invention the transmission protocol employed is WAP and the micro browser 4 is a WAP browser, but the invention is not intended to be restricted to any specific transmission protocol or micro browser. In the preferred embodiment of the invention, the server 1 communicating with the mobile station MS3 is a WAP server and comprising a set of inquiry applications 1, 2 . . . n, but the server 1 may support any transmission protocol compatible with the micro browser 4 in the mobile station MS3. Typically a connection between the WAP browser 4 in the mobile station MS and the application in the WAP server 1 is established through the mobile network 5 to a WAP gateway 2 and further via one or more data network 6 to the WAP server 1. The data network 6 may include local area network (LAN), Intranet, Internet, etc. The WAP server 1 may also be substituted for or embodied in the WAP gateway 2 so that the mobile station MS and the WAP server 1 communicate directly. It should be appreciated that the type of connection and communication between the micro browser 4 in the mobile station 3 and the applications in the server 1 are not relevant to the present invention.

Typically, the communication between the browser 4 and the server 1 is based on sending requests from the browser, processing those requests in the server 1, and sending responses from the server 1 to the browser 4. The response contains all the information required for displaying a browser view, (e.g. WAP page/card/card deck) to the user on a display of the mobile station MS 3. This is also known as “pull” technology, because a client (e.g. MS) “pulls” information from a server.

In contrast to that, another form of communication is a “push” technology, which is also based on client/server model, but where there is no explicit request from the client before the server sends its content. In FIG. 1, the server 1 sends a push message to the MS 7. Naturally, the MS 7 is also able to user the “pull” technology, i.e. send a request and receive a response.

The WAP protocol and architecture employed in the preferred embodiment of the invention is well-known to persons skilled in the art and defined in the specification from wireless application protocol forum. These specifications are available from the wireless application protocol forum web site (http://www.wapforum.org). Mobile stations supporting the WAP are commercially available from a number of manufacturers, such as Nokia. Also software products and toolkits for embodying the standard functions of the WAP gateway 2 and the WAP server 1 are available from Nokia.

As noted above, the WAP server 1 comprises a set of inquiry applications for making data inquiries from a set of databases, such as DB1, DB2 and DB3. These applications typically communicate with the databases over data network(s), such as LANs, Intranet, Internet, etc. It is also possible that inquiry applications are located in two or more servers similar to the WAP server 1, in which case the connection from the mobile station 3 is made to the appropriate WAP server according to the inquiry application selected by the end-user. In the preferred embodiment of the invention the inquiry applications are personalized applications for various users, such as policemen and firemen. Typically, these inquiry applications are using simultaneously multiple of databases.

The inquiry applications may be, for example, offered to the police and the fire and rescue personnel. The inquiry applications offered to the police may include a person check, a driver license check, a vehicle check, a property check, and an address check. Similarly, the inquiry applications offered to the fire department may include an address check, a neighbourhood check, a hazardous material check, and a weather check. All of these inquiry applications are using simultaneously two or more of the databases, such as: a criminal register, a person register, a vehicle register, a wanted list register, a municipal building register, a weather service, etc. By means of these applications, policemen and firemen can easily and automatically obtain critical information relating to their work.

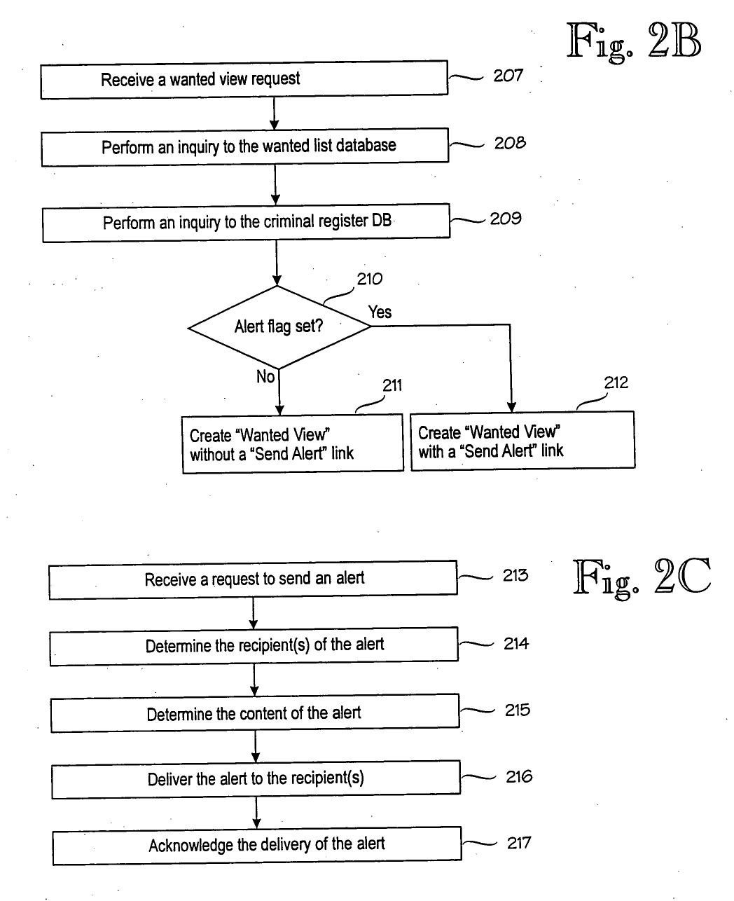

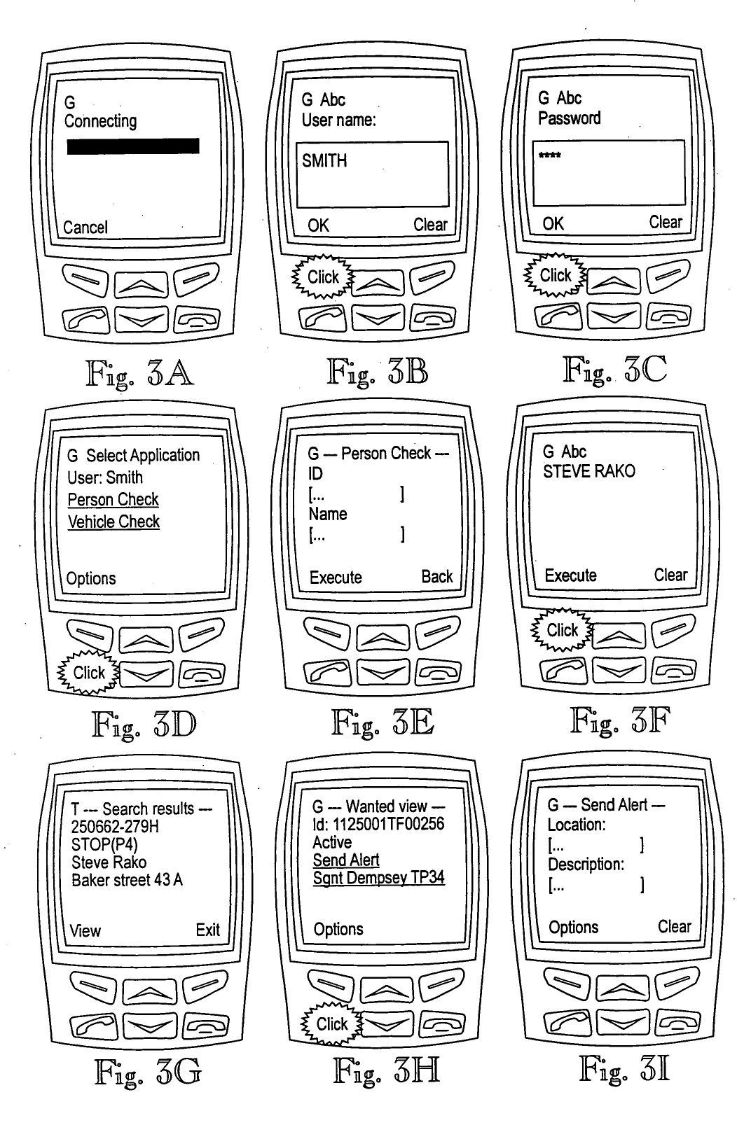

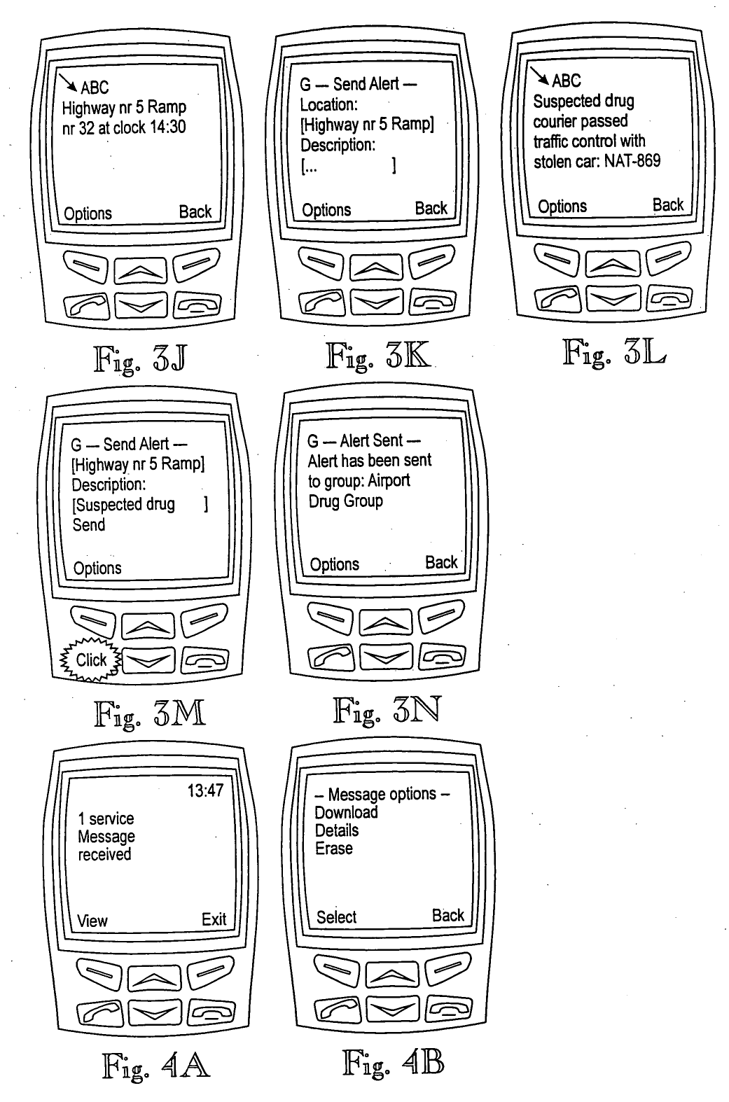

The present invention will be now illustrated by means of an example in which the users are policemen and the inquiry application is the person check, with reference to FIG. 2, FIGS. 3A-3N, and 4A-4C.

Firstly, referring to FIG. 3A, a policeman using his mobile phone provided with the WAP capability, i.e. a WAP browser, initiates a connection to the WAP server 1 in accordance with the WAP procedures. In a response from the server 1, a browser view prompting the user to enter his user name is returned, as shown in FIG. 3B. The user enters his user name “Smith” from the keyboard of the mobile phone and clicks the left button “OK” which is a shortcut for opening a link to the next browser view. As a result, a request with the inputted user name is sent to the server 1 that returns the next browser view requiring a password, as shown in FIG. 3C. The user enters the password “XLRS” and opens the link to the next browser view by clicking the left button “OK”. The password is sent to the server 1 that checks the access rights under the given user name and password. If the user name and the password are accepted, the server 1 allows the user to access to predetermined inquiry services available to the specific user. In this example they are classified applications for police use, namely the person check application and the vehicle check application. The server 1 returns to the browser 4 in the mobile phone a “select application” browser view shown in FIG. 3D. The select application browser view contains links “person check” and “vehicle check” to the respective applications. The user can select one of the links by means of the arrow buttons and then open the link by clicking a predetermined button on the keyboard. In this case the user selects and opens the link to the person check application. The selection is sent to the server 1 which returns the “Person check” view shown in FIG. 3E. In the person check view the user is requested to enter the identity ID, such as the health insurance code, and the name of the person to be searched on the empty lines in FIG. 3E. In FIG. 3F the user has entered the name “Steve Rako” and starts inquiry procedure with his name by opening the execute link.

When the user opens the “execute” link in FIG. 3F, the entered inquiry data (i.e. the name Steve Rako) is sent to the person check application in the server 1. Referring now to FIG. 2A, the person check application receives a person check request for the name Steve Rako (step 200). The person check application now performs a set of proactive inquiries to various databases in order to get information for providing the search results view 31 as a response. More specifically, the person check application performs proactive inquiries to the public person database and the wanted list database (step 201). The inquiry to the public person database gives more specific information on Steve Rako, such as the address and the health insurance code (or another ID). The inquiry to the wanted list(s) database is for checking the status of Steve Rako. The wanted list database contains list(s) of persons who are sought for or followed by the police. In this exemplary embodiment of the invention, a name of a wanted person on the wanted list database is associated with an alert flag that is set active if a policeman shall perform a silent alert when the person is met. As an alternative to the alert flag, the need for a silent alert can be indicated by a specific classification of the person, or simply by keeping a dedicated list of persons for whom a silent alert is required.

Then the person check application checks whether Steve Rako is a wanted person, i.e. whether this name was found in the wanted list database (step 202). If Steve Rako is not a wanted person, the application creates a “search results” browser view indicating a person status “Ok” (step 203).

If Steve Rako is a wanted person, the application creates a “search results” browser view indicating a person status “STOP” (step 204). The status “STOP” is also associated with a number code that can have values from 0 to 5, for example. This code describes the seriousness or status of the wanted list. The letter P stands for a person and the letter V stands for a vehicle. The number code may indicate the following statuses, for example: 0=ask questions, possible witness; 1=petty suspect; 2=suspect for crime; 3=wanted criminal; 4=let go, but inform forward immediately; and 5=armed and dangerous criminal. Thus, the person status in the browser view gives relevant information on the person to be sought and enables the user to make decisions without necessarily accessing the wanted list database.

In this exemplary case Steve Rako is a wanted person, and therefore “search results” browser view is created according to the step 204. The search results view may contain also other information that is not, however, relevant to the present invention.

An example of the search results view is shown in FIG. 3G. Under the title “search results” the first line indicates the health insurance code of Steve Rako. This also serves as an intelligent link to the public person database. The search results view of FIG. 3G also displays the name and address of Steve Rako.

The second intelligent link in FIG. 3G is the status “STOP(P4)” of Steve Rako. As explained above, the content of this link is created on the basis of the proactive inquiry made to the wanted list database. In response to the activation of the person status link, a “wanted view” request is sent to the person check application in the server 1. Referring now to FIG. 2B, the person check application receives the wanted view request for the name Steve Rako (step 200). The person check application now performs a new inquiry to the wanted list database and reads the status of the send alert flag for Steve Rako (step 208). The person check application also performs an inquiry to the criminal register database (step 209). Then the application checks whether the silent alert flag of Rako is set active (step 210). If the silent alert flag is not active, the application creates a “Wanted” browser view without a “send alert” link (step 211). If the silent alert flag is active, the application creates a “Wanted” browser view with a “send alert” link (step 212). The wanted list view contains also other information that is not relevant to the present invention, however.

An example of the wanted list view is shown in FIG. 3H. The first line is an intelligent link created on the basis of the proactive inquiry to the criminal register database. The name of the link indicates the serial number of the relevant criminal record (00256), the type of the crime (TF), and the date of the entry (112501). The second line indicates that the case is active. The bottom line contains an intelligent link with a name that indicates the name (Sgt Dempsey TP34) of a detective handling the case. If this link is activated, the person check application will make a further inquiry to the work force database and create a contact view containing information how to contact the detective.

The “send alert” line provides a link to a send alert view, and thereby activates a procedure for sending a silent alarm.

The user activates this link by clicking a preset button in the keyboard. The request for a “send alert” view is sent to the application in the server 1, and a “send alert” browser view is returned to the browser 4. The “send alert” view may be any view that allows the user to create and send a silent alert message in order to inform predetermined parties that he has important and urgent information to share with them. The alarm message may contain any information in any format entered and/or selected by the user and/or the relevant application in the server 1. For example, the message may contain free textual data, and it may also contain information about the location of the sender, a time stamp or other sender-related information. This other information may be retrieved from internal databases SDV of the mobile network 5, for example.

An example of the send alert view or views is shown in FIG. 3I. The send alert view contains empty line that functions as a link to an editing mode. The user opens this link by clicking a predetermined button in the keyboard, and an editing mode view is opened. The user can now enter a desired location and time information from the keyboard as shown in FIG. 3I. When the user exits the editing mode by clicking a predetermined button, the send alert view is displayed again. The only difference to the original send alert view shown in FIG. 3I is that the location line contains some of the entered location information in the brackets. The next empty line is a link to the editing mode for entering description of the informed event. The user activates this link by clicking a predetermined button, and an editing mode view is opened. The user can now enter the description as shown in FIG. 3L. When the user exits the editing mode, a send alert view is redisplayed with some of the entered description being shown in the brackets on the description line. The user can scroll the send alert view in order to display a “send” link as shown in FIG. 3M. The user activates the send link by clicking a predetermined button in the keyboard, and a request to send a message is delivered to the application in the server 1. Referring now to FIG. 2C, the application in the server 1 receives the request to send an alert (step 213). Then the application determines the recipient or recipients of the alert (step 214). This can be made, for example, by inquiring the contact information from the work force database on the basis of the names or other identity data of the person(s) handling the case. Then the application determines the content of the alert. In this case the content of the alert is that entered by the sending end-user, and possibly some additional information automatically entered by the application. The content of the alert may also contain link or links to additional information relating to the case so that the recipient(s) can start to follow up the case immediately. After that the alert is delivered to the recipient or recipients (step 216), and the delivery of the alert is acknowledged to the sending user (step 217), e.g. by sending to the browser 4 an “alert sent” view shown in FIG. 3N. In this case the recipient is informed to the sending user. However, in some cases the identity of the recipient may be hidden from the sender because of case security or other police tactical reasons.

In the preferred embodiment of the invention the alert is delivered by sending WAP push messages from the server 1 to the recipient(s). The push message may contain all the information entered by the sending user and the application so that the recipient can read the message content by browsing and scrolling the message view on the display of his mobile device. If the content contains a link for inquiring further information, the recipient can open further views by activating the link. An alternative way to deliver the alert is to send a push message informing that the server 1 has a message waiting. If the recipient wants to view the message, he can activate a link requesting the server 1 to send the message. The server 1 may respond to such request with an authentication procedure, e.g. similar to that explained with reference to FIGS. 3B and 3C. After that, the server 1 may send the actual message, or alternatively a menu view having links to download the message, to get further details relating to the case, or to erase the message. In the latter case the user would normally activate the download link, which would cause the server 1 to return the content of the message in a message view. When the user returns from the message view to the message menu, he is then able to get more information by activating the details link, or to erase the message from the server by activating the erase link.

In the above embodiments, the user who inquired the information in the first place triggers the delivery of the silent alert. However, in an embodiment of the invention the inquiry application used by the end-user triggers the delivery of the alert automatically, without intervention or knowledge of the end-user. The condition for sending the alert flag may be similar to that used in FIGS. 2A and 2B. In other words, when the application in the embodiment of FIGS. 2A and 2B makes a decision to provide the “wanted view” with a “send alert” link, the embodiment employing the automated delivery will deliver the alert instead. The delivery of the alert may be similar to that used in the user-triggered delivery, except that the content of the alert is totally created by the inquiry application and the delivery is not acknowledged to the inquiring end-user.

As an alternative to the above embodiments, the checking whether the alert flag is set active can be made already after the checking step 202 as illustrated by the block 210′ in FIG. 2A, and if the alert flag is active, to create a “search result” browser view with a person status “STOP” and a “send alert” link, as illustrated by the block 204′ in FIG. 2A. In that case, the user does not have to open the “wanted view” in order to see the “send alert” link, as in the previous embodiment. Activation of the send alert link in the search results view will trigger the delivery of the alert in a similar manner as the send alert link in the wanted view.

It will be obvious to a person skilled in the art that, as technology advances, the inventive concept can be implemented in various ways. The invention and its embodiments are not limited to the examples described above but may vary within the scope of the claims.

1. A method of providing database inquiry services for a user communication device of a communication system, said method comprising
receiving a data inquiry request to an inquiry service from a browser of said user communication device,
sending an inquiry response to said browser of said user communication device,
providing said inquiry response with a trigger link in response to meeting a predefined condition in the inquiry,
in response to activating said trigger link by a user of said user communication device, creating and delivering a notification to one or more predetermined recipient.

2. A method of providing database inquiry services for a user communication device of a communication system, said method comprising
receiving a data inquiry request to an inquiry service from a browser of said user communication device,
sending an inquiry response to said browser of said user communication device,
in response to meeting a predefined condition in the inquiry, creating and delivering a notification to one or more predetermined recipient.

3. A method according to claim 1, wherein said step of creating comprises
receiving a notification content inputted by the user of said communication device.

4. A method according to claim 1, said step of delivering comprises
delivering said notification as a push delivery to said one or more recipients.

5. A method according to claim 1, wherein said notification contains one or more of the following: free textual data, and information link for inquiring further information, information about the location of said user, a time stamp, and sender-related information retrieved from an internal database of said communications system or said inquiry service.

6. A method according to claim 2, wherein said notification contains one or more of following: free textual data, an information link for inquiring further information, information about the location of said user, a time stamp, and sender-related information retrieved from an internal database of said communications system or said inquiry service.

7. (canceled)

8. A method according to claim claim 5, comprising, in response to activating said information link by said one or more predetermined recipient, providing said recipient with further information.

9. A server for providing database inquiry services for a user communication device of a communications system, comprising
means for receiving a data inquiry request to an inquiry service from a browser of said user communication device,
means for sending an inquiry response to said browser of said user communication device,
means for providing said inquiry response with a trigger link in response to meeting a predefined condition in the inquiry,
means responsive to activating said trigger link by a user of said user communication device, for creating and delivering a notification to one or more predetermined recipient.

10. A server for providing database inquiry services for a user communication device of a communications system, comprising
means for receiving a data inquiry request to an inquiry service from a browser of said user communication device,
means for sending an inquiry response to said browser of said user communication device,
means responsive to meeting a predefined condition in the inquiry, for creating and delivering a notification to one or more predetermined recipient.

11. A server according to claim 9, wherein said notification contains data inputted by the user of said communication device.

12. A server according to claim 9, wherein said notification is a push message.

13. A server according to claim 9, wherein said notification contains one or more of: free textual data, an information link for inquiring further information, information about the location of said user, a time stamp, and sender-related information retrieved from an internal database of said communications system or said inquiry service.

14. A server according to claim 10, wherein said notification contains one or more of following: free textual data, an information link for inquiring further information, information about the location of said user, a time stamp, and sender-related information retrieved from an internal database of said communications system or said inquiry service.

15. (canceled)

16. A server according to claim 13, comprising means responsive to activating said information link by said one or more predetermined recipient, for providing said recipient with further information.

17. A server according to claim 9, wherein the communication system is a wireless communication system, said browser is a micro browser for a wireless application protocol (WAP), and the notification is a WAP push message.

18. A communications system comprising user communications devices and a network unit for providing database inquiry services for a user communication device of a communications system, said network unit comprising
means for receiving a data inquiry request to an inquiry service from a browser of said user communication device,
means for sending an inquiry response to said browser of said user communication device,
means for providing said inquiry response with a trigger link in response to meeting a predefined condition in the inquiry,
means responsive to activating said trigger link by a user of said user communication device, for creating and delivering a notification to one or more predetermined recipient.

19. A computer program product comprising program code means stored on a computer readable medium for performing, when the program is run on a computer, steps of
receiving a data inquiry request to an inquiry service from a browser of said user communication device,
sending an inquiry response to said browser of said user communication device,
providing said inquiry response with a trigger link in response to meeting a predefined condition in the inquiry,
in response to activating said trigger link by a user of said user communication device, creating and delivering a notification to one or more predetermined recipient.

20. A computer program comprising program code means for performing, when the program is run on a computer, steps of
receiving a data inquiry request to an inquiry service from a browser of said user communication device,
sending an inquiry response to said browser of said user communication device,
in response to meeting a predefined condition in the inquiry, creating and delivering a notification to one or more predetermined recipient.

21. A method according to claim 6, comprising, in response to activating said information link by said one or more predetermined recipient, providing said recipient with further information.

22. A server according to claim 14, comprising means responsive to activating said information link by said one or more predetermined recipient, for providing said recipient with further information.

23. A server according to claim 14 wherein the communication system is a wireless communication system, said browser is a micro browser for a wireless application protocol (WAP), and the notification is a WAP push message.
